(19) United States
(12) Patent Application Publication
(10) Pub. No.: US 2016/0191546 A1
(43) Pub. Date: Jun. 30, 2016

(54) APPLICATION MALWARE ISOLATION VIA HARDWARE SEPARATION

(71) Applicant: Spikes, Inc., Los Gatos, CA (US)

(72) Inventor: Branden L. Spikes, Los Gatos, CA (US)

(21) Appl. No.: 14/794,652

(22) Filed: Jul. 8, 2015

Related U.S. Application Data
(63) Continuation of application No. 14/205,855, filed on Mar. 12, 2014.
(60) Provisional application No. 61/777,545, filed on Mar. 12, 2013.

(51) Int. Cl. H04L 29/06; G06F 3/0484

(52) U.S. Cl. CPC H04L 63/1408; H04L 63/0281; G06F 3/04842

(57) ABSTRACT

A system for application malware isolation via hardware separation for use in a networked server-client system in the event of a possible malicious intrusion including a client; and a remote application physically separate from the client, the remote application interactively connected with the client over an encrypted network, the remote application comprising an isolation encoding module configured to create a secure version of potentially malicious client content, the remote application further comprising an application isolation container configured to run operations of interest to the client, so as to perform application malware isolation via hardware separation in the server-client system.

### PRIORITY CLAIM

This application is a continuation application of U.S. patent application Ser. No. 14/205,855, filed Mar. 12, 2014, which claims the benefit of U.S. Provisional Application No. 61/777,545, filed Mar. 12, 2013, each of which is entirely incorporated herein by reference.

### CROSS-REFERENCE TO RELATED APPLICATIONS

This application contains subject matter that is related to the subject matter of the following applications, which are assigned to the same assignee as this application. The below-listed U.S. patent applications are hereby incorporated herein by reference in their entirety:
“DYNAMIC CLIP ANALYSIS,” by Spikes and Sims, filed on Mar. 11, 2014 (Ser. No. 14/205,023).
“TUNABLE INTRUSION PREVENTION WITH FORENSIC ANALYSIS,” by Spikes and Sims, filed on Mar. 11, 2014 (Ser. No. 14/205,085).

### SUMMARY

A system for application malware isolation via hardware separation for use in a networked server-client system in the event of a possible malicious intrusion including a client; and a remote application physically separate from the client, the remote application interactively connected with the client over an encrypted network, the remote application comprising an isolation encoding module configured to create a secure version of potentially malicious client content, the remote application further comprising an application isolation container configured to run operations of interest to the client, so as to perform application malware isolation via hardware separation in the server-client system.

A method for application malware isolation via hardware separation for use in a networked server-client system in the event of a possible malicious intrusion includes providing a remote application connected over a network to a client, wherein the remote application comprises an isolation encoding module and an application isolation container; creating, by the isolation encoding module, a secure version of potentially malicious client content; running, by the application isolation container, operations of interest to the client, so as to perform application malware isolation via hardware separation in the server-client system.

A system for application malware isolation via hardware separation for use in a networked server-client system in the event of a possible malicious intrusion includes a client comprising one or more of a client user interface, a client display system, a client audio system, a client print system, and a client file system; and a remote application physically separate from the client, the remote application interactively connected with the client over an encrypted network, the remote application comprising an isolation encoding module configured to create a secure, re-encoded version of potentially malicious client content and configured to act as one or more of a preview handler, an electronic mail (email) viewer, and a plugin, the remote application further comprising an application isolation container configured to run operations of interest to the client, wherein the application isolation container comprises one or more of an application user interface configured to create a secure version of the client user interface, an application display system configured to create a secure version of the client display system, an application audio system configured to create a secure version of the client audio system, an application print system configured to create a secure version of the client print system, and an application file system configured to create a secure version of the client file system, at least one of which is operably connected with the isolation encoding module, so as to perform application malware isolation via hardware separation in the server-client system.

### DESCRIPTION OF THE DRAWINGS

FIG. 1 is a conceptual block diagram showing an exemplary embodiment of the invention.

FIG. 2 is a flowchart of a method for application malware isolation via hardware separation for use in a networked server-client system.

### DETAILED DESCRIPTION

Malicious software or malware is software used or created by attackers in order to cause problems not intended by the computer owner. The unintended problems may include one or more of computer operation disruption, gathering of sensitive information, and accessing private computer systems. Malware can appear in the form of one or more of code, scripts, active content, and other software. Malware may evolve at a rate that may outpace the capabilities of traditional security software.

Embodiments of the invention physically separate the application from its users via physically separate hardware that may be connected, for example, over an encrypted network. According to embodiments of the invention, interactive display technology may provide a user with a secure barrier to potentially malicious use of that remote application.

Embodiments of the invention isolate malware by quarantining the malware. According to embodiments of the invention, the quarantining of the malware prevents the malware from causing one or more unintended problem. According to embodiments of the invention, the malware applications can then be securely accessed without exposure to risks of malware it may contain, thereby minimizing harm attributable to the malware.

Microsoft Corporation and Citrix Systems both have robust application suites for the remote display of applications, but neither company has adequate security functionality. According to embodiments of the invention, display technology may be used to separate functionality into two separate computers in order to enhance security and minimize the harm that may be caused by malware. According to embodiments of the invention, one or more of clipboard processing, download quarantining, performance enhancement techniques, ease-of-use techniques, active behavioral detection and prevention of malicious activity (sometimes called “tripwires”), and other security techniques may be applied. According to further embodiments of the invention, these techniques may be applied through one or more of the two separate computers.

According to embodiments of the invention, the remote application may comprise a security server different from the application server where processing occurs. According to other embodiments of the application, the remote application may be housed on an encrypted network of servers located in a less secure zone relative to the location of the application server. According to still other embodiments of the invention, the remote application may be housed on one or more unsecure servers. Unsecure servers may comprise Demilitarized Zone (DMZ) networks.

According to embodiments of the invention, live content may be custom rendered using two computers with separated functionality. According to embodiments of the invention, the remote application may be operated on a secure encrypted network. According to other embodiments of the invention, the remote application may be operated on an unsecure server. According to yet other embodiments of the invention, the remote application may be operated on one or more servers with limited access to data. According to still other embodiments of the invention, unsecure applications may thereby be isolated and their potential harm minimized.

Embodiments of the invention may provide heightened security. Embodiments of the invention may provide enhanced performance. Embodiments of the invention may provide enhanced ease of use. Embodiments of the invention may provide enhanced ability to ensure usability of the remote application.

For example, embodiments of the invention may be applied to achieve malware isolation in a context of Internet browsing. As another example, embodiments of the invention may be applied to achieve malware isolation for cloud-based Internet browsing. As another example, embodiments of the invention may be applied to achieve malware isolation for internal private cloud browsing. As another example, embodiments of the invention may be applied to achieve malware isolation for a hybrid browsing context involving a combination of cloud-based Internet browsing and internal private cloud browsing.

As an additional example, embodiments of the invention may be applied to achieve malware isolation by providing a document preview capability for use with one or more applications. For example, according to still other embodiments of the invention, a document preview functionality may be provided in which malware isolation is achieved for Internet-based or web-based access to documents through one or more applications. For example, according to still further embodiments of the invention, a document preview capability may be used with one or more of an electronic mail (email) program, a word processing program, a spreadsheet program, a power point program, a Portable Document File (PDF) program, other office suite programs, and other applications. For example, according to yet other embodiments of the invention, a document preview capability may be used with one or more of Microsoft Word, WordPerfect, Apple Pages, Google Docs, Ted, and another word processing program. For example, according to yet other embodiments of the invention, malware isolation may be achieved with regard to viewing attachments in an electronic mail (email) program comprising one or more of Apple Mail, Microsoft Outlook, Google Mail, Yahoo Mail, Hotmail, and another email program.

As a further example, according to yet other embodiments of the invention, malware isolation may be used for viewing commonly used documents in office suites, including word processing documents, spreadsheets, presentation documents, PDF documents, electronic mail (email) messages, electronic mail attachments, and other programs that may be potentially subject to malware. For example, embodiments of the invention may be applied to provide one or more of a preview handler and a plugin for use with one or more of Microsoft Office, WordPerfect Office, iWork, Google Apps, and another office suite.

According to embodiments of the invention, the preview handler will enable viewing of the document without the client running risk of harm from malware. According to other embodiments of the invention, the plugin enables opening of, modification of, and saving of the document without the client running risk of harm from malware.

For example, embodiments of the invention may be applied to provide one or more of a preview handler and a plugin for use with one or more word processing programs including documents prepared using Microsoft Word, WordPerfect, Apple Pages, Google Docs, Ted, and other word processing programs. As another example, embodiments of the invention may be applied to provide one or more of a preview handler and a plugin for use with one or more spreadsheet programs including documents prepared using Microsoft Excel, Quattro Pro, Apple Numbers, and Lotus 1-2-3. As yet another example, embodiments of the invention may be applied to provide one or more of a preview handler and a plugin for use with one or more presentation documents including documents prepared using Microsoft Power Point, Corel Presentations, Apple Keynote, Lotus Freelance Graphics, and other presentation programs. In the attachment context, a preview handler may be identified as an attachment viewer. According to these embodiments, the attachment viewer will run on the remote security server.

As another example, embodiments of the invention may be applied to achieve malware isolation in regard to office software application suites. As a further example, embodiments of the invention may be applied to achieve malware isolation in regard to one or more of Microsoft Office applications, Google Drive applications, and cloud office suite applications. As still another example, embodiments of the invention may be applied to achieve malware isolation in regard to cloud-based storage of documents for office software application suites. As a yet further example, embodiments of the invention may be applied to achieve malware isolation in regard to cloud-based storage of Microsoft Office documents.

As another example, embodiments of the invention may be applied to achieve malware isolation in regard to a client rendering geographic images or maps. As a further example, embodiments of the invention may be applied to achieve malware isolation in regard to a client rendering geographic images, with the rendering of the geographic images occurring on the remote security server. As a yet further example, embodiments of the invention may be applied to achieve malware isolation in regard to a client using a virtual globe, map, and geographical information program such as, for example, Google Earth. As a still further example, embodiments of the invention may be applied to achieve malware isolation in regard to a remote operating system for running web-based applications.

As another example, embodiments of the invention may be applied to achieve malware isolation in regard to a remote operating system for running web applications. As still another example, embodiments of the invention may be applied to achieve malware isolation in regard to Google's Chrome Operating System (Chrome OS).

As a further example, embodiments of the invention may be applied to achieve malware isolation in regard to a virtual desktop infrastructure (VDI), where an entire desktop is virtualized in the remote security server.

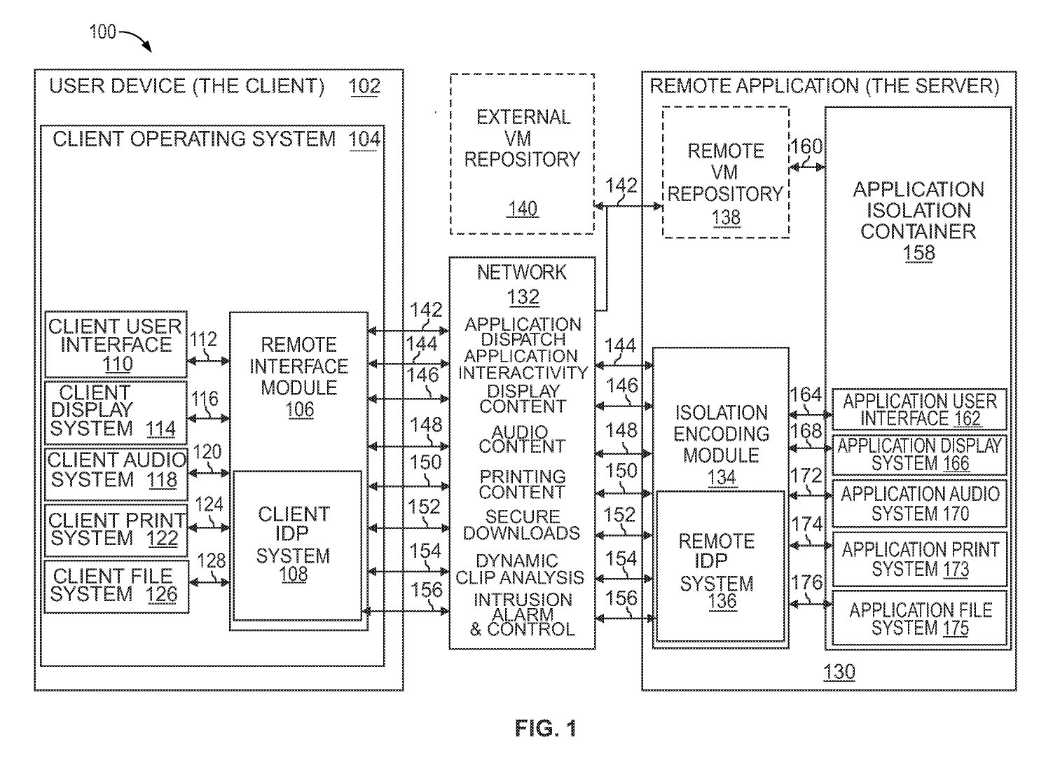

FIG. 1 is a conceptual block diagram showing an exemplary embodiment 100 of the invention. Depicted is a client-server system 100 for application malware isolation via hardware separation, where the client 102 is a user device 102. For example, the user device 102 may be one or more of a personal computer, a laptop computer, a mobile computing device, a tablet, and the like. The client may comprise a client operating system 104. The client operating system 104 may comprise a remote interface module 106.

The remote interface module 106 may comprise a client intrusion detection and prevention (IDP) system 108. The client IDP system 108 may comprise client IDP rules (not shown). The remote application module 106 may be configured to receive input from the client IDP system 108 regarding one or more applicable client IDP rules relating to a possible intrusion event by malicious content.

The client operating system 104 may comprise a client user interface 110. The client user interface 110 may communicate with the remote interface module 106 via a remote interface module-client user interface connection 112. For example, the client user interface 110 may transmit information regarding one or more of user preferences, user configurations, and user behavior to the remote interface module 106 via the remote interface module-client user interface connection 112.

The client operating system 104 may comprise a client display system 114. The client display system 114 may communicate with the remote interface module 106 via a remote interface module-client display system connection 116. For example, the client display system 114 may transmit information regarding one or more of user display preferences, user display configurations, and user display behavior to the remote interface module 106 via the remote interface module-client display system connection 116.

The client operating system may comprise a client audio system 118. The client audio system 118 may communicate with the remote interface module 106 via a remote interface module-client audio system connection 120. For example, the client audio system 118 may transmit information regarding one or more of user audio preferences, user audio configurations, user audio downloads, user audio listens, and user audio behavior to the remote interface module 106 via the remote interface module-client audio system connection 120.

The client operating system 104 may comprise a client print system 122. The client print system 122 may communicate with the remote interface module 106 via a remote interface module-client print system connection 124. For example, the client print system 122 may transmit information regarding one or more of one or more of user print preferences, user print configurations, user print views, user print downloads, user page prints, user document prints, user folder prints, and user print behavior to the remote interface module 106 via the remote interface module-client print system connection 124.

The client operating system 104 may comprise a client file system 126. The client file system 126 may communicate with the remote interface module 106 via a remote interface module-client file system connection 128. For example, the client file system 126 may transmit information regarding one or more of user file preferences, user file configurations, user file views, user file downloads, and user file behavior to the remote interface module 106 via the remote interface module-client file system connection 128.

Alternatively, or additionally, the remote interface module 106 may comprise a web application that runs inside a browser rather than running on the client operating system 104.

The system 100 also may comprise a remote application 130 or server 130. The remote application 130 may be interactively connected to the remote interface module 106 over a network 132 and thereby may be interactively connected to the client 102. The network 132 will preferably be encrypted.

The remote application 130 is physically separate from the client 102 in order to promote security from malicious use of the remote application 130.

The remote application 130 may comprise an isolation encoding module 134. The isolation encoding module 134 may perform encoding, scanning, and policy enforcement. The isolation encoding module 134 creates a re-encoded, secure version of content using techniques disclosed in “DYNAMIC CLIP ANALYSIS,” by Spikes and Sims, filed on Mar. 11, 2014 (Ser. No. 14/205,023). Then the isolation encoding module 134 runs operations of interest to the client 102.

For example, the isolation encoding module 134 may do one or more of word processing, running a spreadsheet, running a presentation, running a Portable Data File (PDF) program, running an electronic mail (email) program, running a cloud office suite, rendering one or more of geographic images and maps, running a virtual globe program, operating a remote operating system for running web-based applications, running a virtual desktop infrastructure, performing cloud-based Internet browsing, performing internal private cloud browsing, performing hybrid browsing involving a combination of cloud-based Internet browsing and internal private cloud browsing, and running another program.

For example, the isolation encoding module may do one or more of running an application user interface configured to create a secure version of the client user interface, running an application display system configured to create a secure version of the client display system, running an application audio system configured to create a secure version of the client audio system, running an application print system configured to create a secure version of the client print system, and running an application file system configured to create a secure version of the client file system, at least one of which is operably connected with the isolation encoding module.

For example, the Isolation encoding module 134 re-encodes content comprised in one or more of a client-side clipboard (not shown) and a client-side drag and drop utility (not shown) so that it has constructed a secure version of the clipboard or a secure version of the drag and drop utility. For example, the Isolation encoding module 134 re-encodes an image before a client downloads it to avoid possible risk from the client 102.

By providing the client 102 with a re-encoded image of the original document, the isolation encoding module 134 functions as one or more of a preview handler and a plugin available for use with office document software.

For example, the Isolation encoding module 134 re-encodes the potentially malicious client content and acts as one or more of a preview handler and a plugin for a PDF document.

For example, the isolation encoding module 134 re-encodes and acts as one or more of a preview handler and a plugin for one or more documents created with one or more word processing programs including documents prepared using one or more of Microsoft Word, WordPerfect, Apple Pages, Google Docs, Ted, and other word processing programs.

For example, the isolation encoding module 134 re-encodes and acts as one or more of a preview handler and a plugin for one or more documents created with one or more spreadsheet programs including documents prepared using one or more of Microsoft Excel, Quattro Pro, Apple Numbers, and Lotus 1-2-3.

For example, the isolation encoding module 134 re-encodes and acts as one or more of a preview handler and a plugin for one or more documents created with one or more presentation programs including documents prepared using one or more of Microsoft Power Point, Corel Presentations, Apple Keynote, Lotus Freelance Graphics, and other presentation programs. According to these embodiments, the attachment viewer will run on the remote application 130.

For example, the system 100 provides malware isolation in regard to office software application suites including one or more of Microsoft Office applications, Google Drive applications, and cloud office suite applications. As still another example, the system 100 provides malware isolation in regard to cloud-based storage of documents for office software application suites. As a yet further example, the system 100 provides malware isolation in regard to cloud-based storage of Microsoft Office documents.

As another example, the system 100 provides malware isolation for a client 102 who is rendering geographic images or maps. As a further example, the system 10 provides malware isolation for a client 102 who is rendering geographic images or maps, with the rendering of the geographic images occurring on the remote application 130. As a yet further example, the system 100 provides malware isolation for a client 102 who is using Google Earth.

As another example, the system 100 provides malware isolation in regard to a remote operating system for running web applications. As still another example, the system 100 provides malware isolation in regard to Google's Chrome Operating System (Chrome OS).

As a further example, embodiments of the invention may be applied to achieve malware isolation in regard to a virtual desktop infrastructure (VDI), where an entire desktop is virtualized in the remote security server.

The re-encoded document can be downloaded, allowing the client to view the original document without incurring any risk from doing so. The dynamic re-creation of content allows the client, according to embodiments of the invention, to be secure from malware.

The isolation encoding module 134 may comprise a remote intrusion detection and prevention IDP system 136. The remote IDP system 136 may comprise remote IDP rules (not shown). The isolation encoding module 134 may be configured to receive input from the remote IDP system 136 regarding one or more applicable remote IDP rules relating to a possible intrusion event by malicious content.

The remote application 130 may optionally comprise a remote virtual machine (VM) repository 138. The system 100 may optionally comprise an external VM repository 140. The isolation encoding module 134 may determine that content is potentially malicious content. One or more of the remote VM repository 138 and the external VM repository 140 may comprise one or more application-specific VM's.

Application-specific VM's may comprise one or more of a media viewer, an electronic mail (email) reader, an office productivity system, an office suite, and another utility able to handle potentially malicious content.

The external VM repository 140 may comprise VM's that are copied via encrypted application dispatch 142 and via the encrypted network 132 from the remote VM repository 138. The remote VM repository 138 may comprise VM's that are copied via encrypted application dispatch 142 and via the encrypted network 132 from the external VM repository 140.

So as to arrange for the display of remote content, the remote interface module 106 may transmit the remote content over the encrypted network 132 to the isolation encoding module 134. The remote interface module 106 may transmit over the encrypted network 132 to the isolation encoding module 134 one of more of application interactivity 144, display content 146, audio content 148, printing content 150, secure downloads 152, dynamic clip analysis (DCA) 154, and intrusion alarm and control 156. Dynamic clip analysis is disclosed in “DYNAMIC CLIP ANALYSIS,” by Spikes and Sims, filed on Mar. 11, 2014 (Ser. No. 14/205,023). While passing over the encrypted network 132, encryption will be performed on the one of more of application interactivity 144, display content 146, audio content 148, printing content 150, secure downloads 152, and DCA 154. Additionally, the client IDP system 108 may communicate with the remote IDP system 136 over the encrypted network 132 via the encrypted intrusion alarm and control 156.

The remote application 130 may comprise an application isolation container 158. The application isolation container 158 may actively stop malware behavior. The application isolation container 158 may communicate with the remote VM repository 138 via an application isolation container-remote VM repository connection 160.

As needed to execute operations in one or more of the application user interface 162, the application display system 166, the application audio system 170, the application print system 173, and the application file system 175, the client 102 instructs the remote interface module 106 to send a needed application-specific VM (not shown) via application dispatch 142 and via the network 132 to the remote VM repository 138 and on to the application isolation container 158 so that the needed application-specific VM can be utilized. The application-specific VM is then available to enable the client 102 to safely access the potentially malicious content.

The application isolation container 158 may comprise an application user interface 162. The application user interface 162 may communicate with the isolation encoding module 134 via an isolation encoding module-application user interface connection 164. For example, the application user interface 162 may transmit information regarding one or more of user preferences, user configurations, and user behavior to the isolation encoding module 134 via the isolation encoding module-application user interface connection 164.

The application isolation container 158 may comprise an application display system 166. The application display system 166 may communicate with the isolation encoding module 134 via an isolation encoding module-application display system connection 168. For example, the application display system 166 may transmit information regarding one or more of user display preferences, user display configurations, and user display behavior to the isolation encoding module 134 via the isolation encoding module-application display system connection 168.

The application isolation container 158 may comprise an application audio system 170. The application audio system 170 may communicate with the isolation encoding module 134 via an isolation encoding module-application audio system connection 172. For example, the application audio system 170 may transmit information regarding one or more of user audio preferences, user audio configurations, user audio downloads, user audio listens, and user audio behavior to the isolation encoding module 134 via the isolation encoding module-application audio system connection 172.

The application isolation container 158 may comprise an application print system 173. The application print system 173 may communicate with the isolation encoding module 134 via an isolation encoding module-application print system connection 174. For example, the application print system 173 may transmit information regarding one or more of user print preferences, user print configurations, user print views, user print downloads, user page prints, user document prints, user folder prints, and user print behavior to the isolation encoding module 134 via the isolation encoding module-application print system connection 174.

The application isolation container 158 may comprise an application file system 175. The application file system 175 may communicate with the isolation encoding module 134 via an isolation encoding module-application file system connection 176. For example, the application file system 175 may transmit information regarding one or more of user file preferences, user file configurations, user file views, user file downloads, and user file behavior to the isolation encoding module 134 via the isolation encoding module-application file system connection 176.

For example, embodiments of the system 100 may be applied to achieve malware isolation in a context of Internet browsing. As another example, embodiments of the system 100 may be applied to achieve malware isolation for cloud-based Internet browsing. As another example, embodiments of the invention may be applied to achieve malware isolation for internal private cloud browsing. As another example, embodiments of the invention may be applied to achieve malware isolation for a hybrid browsing context involving a combination of cloud-based Internet browsing and internal private cloud browsing.

The system 100 may offer additional security measures including one or more of clipboard processing, download quarantining, performance enhancement techniques, ease-of-use techniques, active behavioral detection and prevention of malicious activity (also known as “tripwires”), and other security techniques. The system 100 may provide heightened security. The system 100 may provide enhanced performance. The system 100 may provide enhanced ease of use. The system 100 may provide enhanced ability to ensure usability of the remote application 130.

According to embodiments of the invention, the remote application 130 may comprise a security server different from the user device 102 where processing occurs. According to other embodiments of the invention, the remote application 130 may be housed on an encrypted network of servers located in a less secure zone relative to the location of the user device 102. According to still other embodiments of the invention, the remote application 130 may be housed on one or more unsecure servers. According to yet other embodiments of the invention, the unsecure servers may comprise one or more DMZ networks.

According to embodiments of the invention, the system 100 may custom render live content using two computers with separated functionality. According to other embodiments of the invention, the two computers with separated functionality may comprise the user device 102 and the remote application 130. According to yet other embodiments of the invention, the remote application 130 may be operated on a secure encrypted network. According to still other embodiments of the invention, the remote application 130 may be operated on an unsecure server. According to yet further embodiments of the invention, the remote application 130 may be operated on one or more servers with limited access to data. According to still further embodiments of the invention, unsecure applications may thereby be isolated and their potential harm minimized.

Embodiments of the invention may be useful for facilitating the secure provision by a company of access to its servers and internal applications to people lacking a high established trust level. A company can place its servers on a secure encrypted network established according to embodiments of the invention, thereby allowing access to one or more of contractors, part-time employees, interns, and people using unsecure devices without compromising company security.

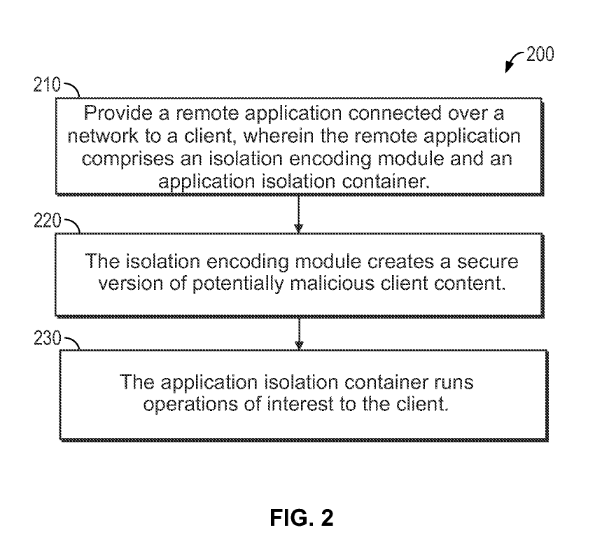

FIG. 2 is a flowchart of a method 200 for application malware isolation via hardware separation for use in a networked server-client system. The order of the steps in the method 200 is not constrained to that shown in FIG. 2 nor is it constrained to that described in the following discussion. Several of the steps could occur in a different order without affecting the final result.

In block 210, a remote application connected over a network to a client is provided, wherein the remote application comprises an isolation encoding module and an application isolation container. Block 210 then transfers control to block 220.

In block 220, the isolation encoding module creates a secure version of potentially malicious client content. Block 220 then transfers control to block 230.

In block 230, the application isolation container runs operations of interest to the client. Block 230 then terminates the process.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

For example, it will be understood by those skilled in the art that certain components can be located in different positions than is described in the specification and depicted in the figures. For example, the remote application module 106 could be located outside the client 102 without any necessary loss of functionality. As another example, without any necessary loss of functionality, the application isolation container 158 could be located in one remote application and could be connected by a remote network to an isolation encoding module 134 that is located in a second remote application. As another example, it will be understood by those skilled in the art that the remote application can be run on a non-secure demilitarized zone (DMZ) network. As still another example, it will be understood by those skilled in the art that the remote application can be run on a sandbox, which may result in additional available security functionality. It is intended, therefore, that the subject matter in the above description shall be interpreted as illustrative and shall not be interpreted in a limiting sense.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the appended claims.

1.-20. (canceled)

21. A secure system for providing user interaction with client content, a user accessing the system through a client, the system comprising:
a server, the server operable to communicate with client content providers;
a data store comprising preferences associated with the user for interacting with the client content; and
a server comprising a browser, the browser including data retrieved from the data store and an application, the application operable within the browser of the server to receive client content from the client content providers,
whereby the application server is operable to enable browsers that are operated outside the client such that the client receives content representative of client content without receiving the client content from the client content providers.

22. A method for establishing a secure browser operating in a secure zone, the method comprising:
a) providing a client operable to display content representative of client content without receiving client content from a client content provider;
b) establishing a client operating system on the client operable to display content representative of client content without receiving client content from client content providers, the client operating system operable to communicate directly with the secure zone;
c) establishing a user interface on the client operating system, whereby the communications between the secure zone and the client operating system may be conducted through the user interface; and
d) establishing a secure browser, the secure browser including data retrieved from a data store, the secure browser operable as the interface point to the client operating system, the browsing operable to interact with the client content providers from within the secure browser and thereby isolate the client from the internet.

23. A method for redirecting content on a client device to Internet browsing operating in a secure zone, the method comprising:
a) establishing on the client device a client operating system, the client operating system being a client to the secure zone and operable to communicate directly with the secure zone;
b) establishing links in one or more applications running on the client device whereby the secure zone receives content submitted within those applications; and
c) transmitting the content through the client operating system to a server in the secure zone, the server to initiate Internet browsing with a client content provider associated with the content, the browser including data retrieved from a data store, the server further operable to enable browsers that are operated outside the client device,
whereby the client device is operable to display content representative of client content without receiving the client content from the client content providers.
